(19) United States
(12) Patent Application Publication
(10) Pub. No.: US 2018/0056536 A1
(43) Pub. Date: Mar. 1, 2018

(54) Novel Device for Affixing a Shaving Razor to a Can of Shaving Cream

(71) Applicant: Carl Fiedler, Leesburg, FL (US)

(72) Inventor: Carl Fiedler, Leesburg, FL (US)

(21) Appl. No.: 15/682,855

(22) Filed: Aug. 22, 2017

Related U.S. Application Data
(60) Provisional application No. 62/379,396, filed on Aug. 25, 2016.

(51) Int. Cl. B26B 21/44

(52) U.S. Cl. CPC B26B 21/44; B65D 83/285

(57) ABSTRACT

Devices for affixing a shaving razor to a can of shaving cream are disclosed. Specifically, a hook with a magnet is affixed to the handle of a shaving razor allowing the user to attach the shaving razor to a can of shaving cream is disclosed. Alternate embodiments that are affixed to the razor by means of an flexible band and by an adhesive area are also disclosed.

### CROSS-REFERENCE TO RELATED APPLICATIONS

This application takes reference to U.S. Prov. Pat. No. 62/379,396 filed Aug. 25, 2016 and incorporates it in its entirety by reference.

### FIELD OF THE INVENTION

The present invention relates to devices for affixing a shaving razor to a can of shaving cream. Specifically, the present invention relates to a magnetic hook affixed to the handle of a shaving razor allowing the user to attach the shaving razor to a can of shaving cream.

### BACKGROUND OF THE INVENTION

Currently, there are numerous methods for hanging shaving razors from various fixtures. For example, U.S. Pat. App. 2010/0301063 discloses various appliances for hanging a shaving razor from a device affixed to the top of a can of shaving cream. Included in this piece of prior art is a razor handle with an integral hook designed to fit over a separate part of the device affixed to the top of a can of shaving cream. Similarly, U.S. Pat. No. 4,432,136 discloses a razor with a handle with integral hooks for affixing the razor to a neighboring razor in a retail stack of razors.

But absent from the prior art is any indication of a hook device affixed to the handle of a razor for hanging the razor from a cap securing seam of a can of shaving cream. Such seams are present on virtually all cans but are ordinarily covered by a cap or top. If the cap or top is removed and discarded, a ridge for hanging the handle of a razor is revealed.

Thus, it is a first goal of the present invention to provide a novel device for affixing a shaving razor to the cap securing seam of a can of shaving cream.

It is a second goal of the present invention to provide a novel device for affixing a shaving razor to a planar or circularly disposed near planar surface of a steel can of shaving cream.

It is a third goal of the present invention to provide a novel device for affixing a shaving razor to a can of shaving cream such that the device may be affixed adhesively to the razor.

It is a fourth goal of the present invention to provide a novel device for affixing a shaving razor to a can of shaving cream such that the device may be removably affixed to the razor.

### SUMMARY OF THE INVENTION

The exemplary embodiment of the present invention comprises the following components: 1) A razor shaft and head; 2) An exposed hook permanently affixed to the shaft of the razor; and, 3) A magnet affixed to the interior aspect of the exposed hook of the razor.

An alternative embodiment of the present invention comprises a flexible band for affixing the exposed hook to the shaft of the razor.

A second alternative embodiment of the present invention comprises an adhesive area for affixing the exposed hook to the shaft of the razor.

The exemplary embodiment of the present invention is used in the following manner: First, the user removes and discards the plastic cap of a can of shaving cream. Next, the user shaves using the razor and cream from the shaving cream can. Next, the user completes shaving and rinses the blades of the razor. Next, the user hangs the razor from the cap securing seam of the can of shaving cream. Next, the user stores the can of shaving cream with the razor attached.

An alternative embodiment is used by activating the adhesive area for affixing the exposed hook to the shaft of the razor and affixing it to the razor.

A second alternative embodiment is used in the following manner: First, locate the exposed hook on a suitable area on the shaft of the razor. Next, pass the flexible band over the handle of the razor and over the mounting tab of the device.

### BRIEF DESCRIPTION OF THE DRAWINGS

FIG. 1 is an elevation view of a razor showing the top surface of the razor with the hook affixed.

FIG. 2 is an elevation view of a razor showing the side surface of the razor with the hook affixed.

FIG. 3 is a close-up, oblique view of a razor showing the hook affixed.

FIG. 4 is an oblique view of an alternative embodiment of the invention showing an elastic band used to affix it to the shaft of a razor.

FIG. 5 is an oblique view of a second alternative embodiment of the invention showing an adhesive area used to affix it to the shaft of a razor.

### DETAILED DESCRIPTION OF THE PREFERRED EMBODIMENT

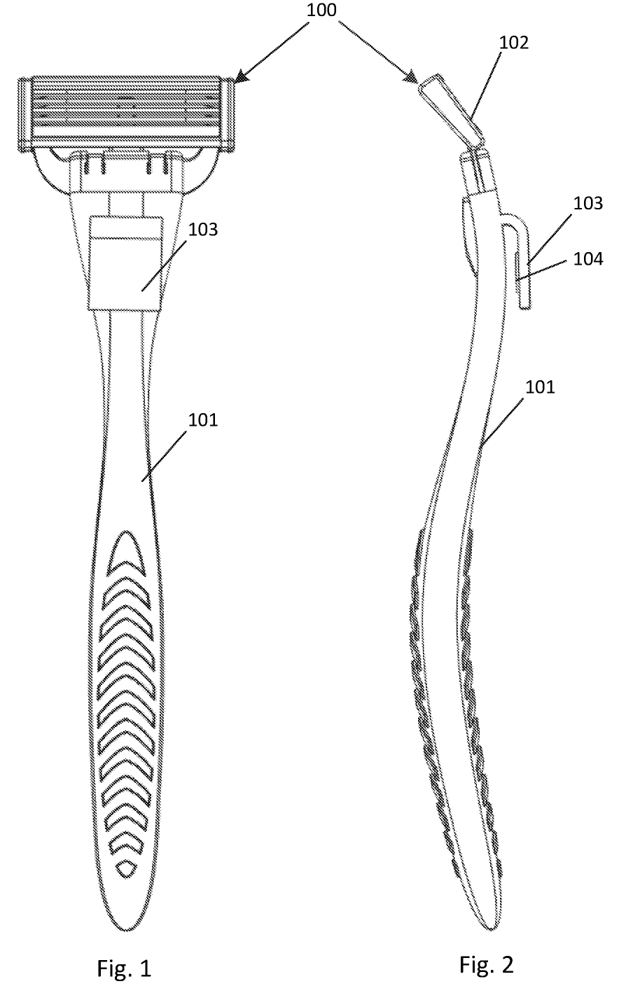

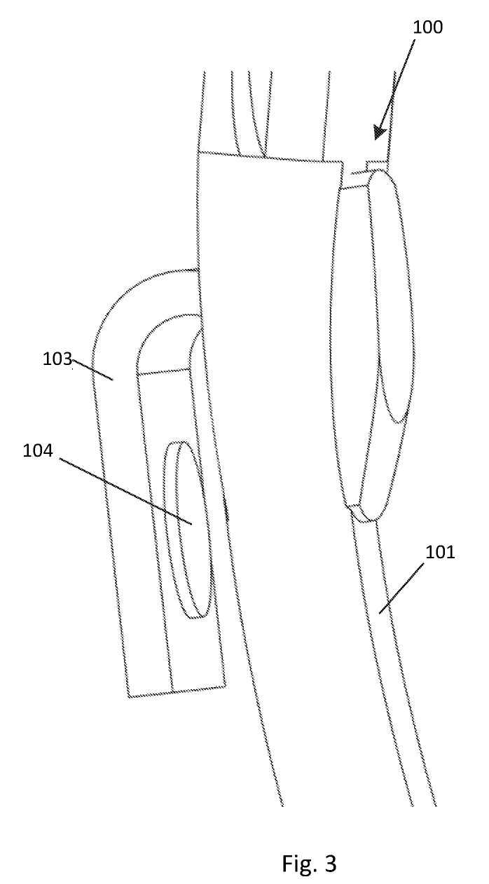

Referring now to FIGS. 1, 2, and 3, the exemplary embodiment of the present invention 100 comprises the following components: 1) Razor shaft 101 and head 102; 2) Exposed hook 103 permanently affixed to razor shaft 101; and, 3) Magnet 104 affixed to exposed hook 103. Razor 100 is manufactured out of plastic, polycarbonate, or fiber-plastic material ordinarily molded into its final shape. Razor 100 may alternately be manufactured out of metal. The blades of head 102 may be steel or other suitable material. In this embodiment of the present invention, exposed hook 103 is molded as part of razor shaft 101 of razor 100. Magnet 104 is inserted, or molded, into the inner aspect of exposed hook 103.

It will be readily apparent to those having skill in the art that the width of exposed hook 103 may be varied from that illustrated. For example, the width of exposed hook 103 may be less than that disclosed in FIGS. 1, 2, and 3. If it is less than that illustrated, exposed hook 103 may be insinuated in a cut-out region on the opposite side of razor shaft 101 such that exposed hook 103 may be stored in the cut-out region when a plurality of razors are stacked on top of one another in retail packaging.

Magnet 104 is included hidden on the underside of exposed hook 103 so that adhesion between razor 100 and a can of shaving cream can be maximized. Alternately, it will be readily obvious to those having skill in the art that razor 100 may also be affixed to semi-planar steel surfaces of shaving cream cans without a cap securing seam by means of the attractive force between magnet 104 and any ferrous surface. It will be readily obvious that in this case, magnet 104 may be affixed, or molded into, the outside surface of exposed hook 103. Similarly, it will be readily obvious to those having skill in the art that razor 100 may also be affixed to a can of shaving cream with a cap securing seam without the need for magnet 104 and that in such an implementation razor 100 need not be manufactured with magnet 104. Similarly, it will be readily obvious to those having skill in the art that razor 100 when manufactured of, or containing, some ferrous material may also be affixed to a can of shaving cream if magnet 104 is attached, or otherwise affixed to, the can of shaving cream.

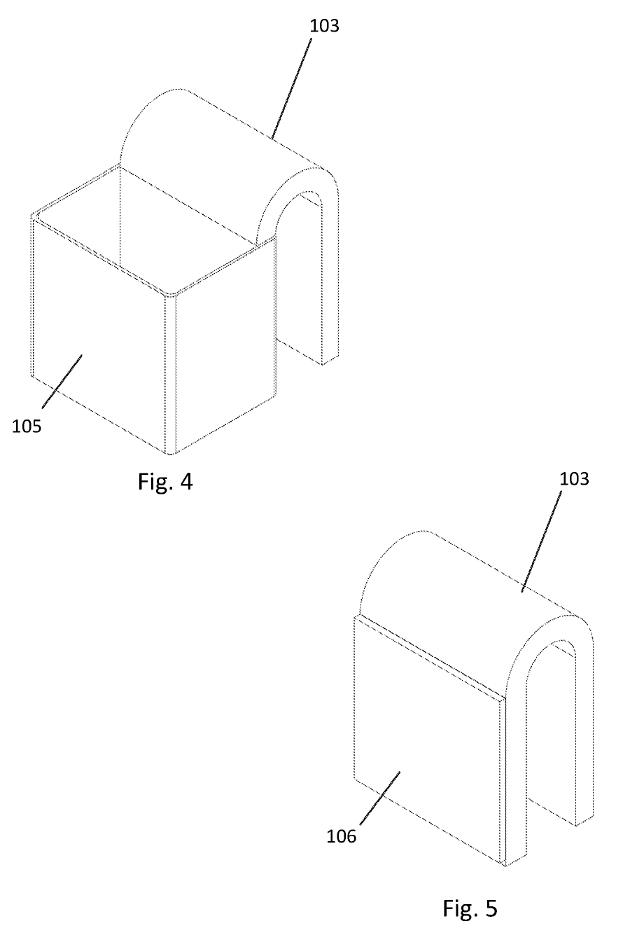

Turning now to FIG. 4, an alternative embodiment of the present invention comprises a flexible band 105 for affixing exposed hook 103 to the shaft of the razor. Exposed hook 103 is manufactured out of plastic, polycarbonate, or fiber-plastic material ordinarily and is molded into its final shape. Exposed hook 103 may alternately be manufactured out of metal. Flexible band 105 is ordinarily comprised of synthetic rubber (e.g. thermoplastic elastomer).

Turning now to FIG. 5, a second alternative embodiment of the present invention comprises adhesive area 106 for affixing exposed hook 103 to the shaft of the razor. Exposed hook 103 is manufactured out of plastic, polycarbonate, or fiber-plastic material ordinarily and is molded into its final shape. Exposed hook 103 may alternately be manufactured out of metal. In manufacturing, ordinarily adhesive area 106 is a piece of double-sided sticky tape or foam with one side firmly affixed to the shaft of the razor and the other side covered in paper for commercial storage.

Returning to FIGS. 1, 2, and 3, the exemplary embodiment of the present invention is used in the following manner: First, the user removes and discards the plastic cap from a can of shaving cream. Next, the user shaves using razor 100 and cream from the shaving cream can. Next, the user completes shaving and rinses the blades of head 102 of razor 100. Next, the user hangs razor 100 from the cap securing seam of the can of shaving cream by means of exposed hook 103. Next, the user stores the can of shaving cream with razor 100 attached.

In situations where the can of shaving cream has no visible cap securing seam, the user hangs razor 100 from the side of can of shaving cream by means of magnet 104.

Returning now to FIG. 4, the alternative embodiment of exposed hook 103 is affixed to razor shaft 101 of razor 100 by means of flexible band 105. This embodiment allows the user to affix exposed hook 103 to several razors 100.

Returning now to FIG. 5, a second alternative embodiment of exposed hook 103 is affixed to razor shaft 101 of razor 100 by removing the paper protective cover from adhesive area 106 and adhering exposed hook 103 to razor shaft 101 of razor 100 at a user selectable location.

It will be readily apparent to those having skill in the art that numerous other refinements may be made to the second alternative embodiment of exposed hook 103. For example, adhesive area 106 may be replaced by a set of hook and loop adhering pads, one adhesively affixed to the can of shaving cream and the other adhesively affixed to razor shaft 101 of razor 100. Razor 100 may then be stored by affixing one of these hook and loop pads to the other.

What is claimed is:

1. A shaving razor comprising:
a) a razor with a head and a generally perpendicular shaft;
b) an exposed hook affixed to said shaft; and
c) a magnet attached to the interior aspect of said exposed hook.

2. A shaving razor of claim 1 wherein the exposed hook is molded as part of the shaft of the razor.

3. A shaving razor of claim 1 wherein the exposed hook is affixed to the shaft of the razor using an flexible band.

4. A shaving razor of claim 1 wherein the exposed hook is affixed to the shaft of the razor using an adhesive area.

5. A shaving razor of claim 1 wherein the exposed hook is affixed to the shaft of the razor on the same side of the blades.

6. A shaving razor of claim 1 wherein the exposed hook is affixed to the shaft of the razor on the opposite side of the blades.
